(19) United States
(12) Patent Application Publication
(10) Pub. No.: US 2013/0235601 A1
(43) Pub. Date: Sep. 12, 2013

(54) ILLUMINATION DEVICE AND VEHICLE HEADLAMP

(71) Applicant: SHARP KABUSHIKI KAISHA, Osaka-shi (JP)

(72) Inventor: Koji TAKAHASHI, Osaka-shi (JP)

(73) Assignee: SHARP KABUSHIKI KAISHA, Osaka-shi (JP)

(21) Appl. No.: 13/793,820

(22) Filed: Mar. 11, 2013

(30) Foreign Application Priority Data
Mar. 12, 2012 (JP) 2012-055085

(51) Int. Cl. F21S 8/10; F21V 9/00

(52) U.S. Cl. CPC F21S 48/12; F21V 9/00
USPC 362/465; 362/84; 362/510

(57) ABSTRACT

A headlamp in accordance with one aspect of the present invention is configured such that a first light source is provided at a focal position of a parabolic mirror, a second light source is provided in a position different from the focal position, and lighting of each of the first and second light sources is controlled, whereby a light-projection pattern is changed.

This Nonprovisional application claims priority under 35 U.S.C. §119 on Patent Application No. 2012-055085 filed in Japan on Mar. 12, 2012, the entire contents of which are hereby incorporated by reference.

### TECHNICAL FIELD

The present invention relates to an illumination device and a vehicle headlamp.

### BACKGROUND ART

In recent years, an adaptive front-lighting system (AFS, light distribution control type headlamp system) has been developed, which improves visibility during vehicle driving in order to prevent accidents at intersections and curves at night. The adaptive front-lighting system improves the visibility by projecting, according to the steering of the vehicle, light from a headlamp in a direction in which the vehicle is about to travel so that the light is suitable for road conditions. According to this technique, the light is projected in a desired direction by for example changing an angle of (by rotating) (i) an entire light-projection section which is constituted by a light source and a reflecting mirror or (ii) only a part of the reflecting mirror.

However, this configuration requires another constituent(s) (motor, gear, control system and/or the like) in order to mechanically move the reflecting mirror etc. As a result, this configuration increases in weight, becomes more difficult to control, and has poor responsivity. Furthermore, the configuration which mechanically moves the reflecting mirror etc. is susceptible to environment (e.g. temperature, humidity and dust), and thus is liable to troubles.

Patent Literature 1 discloses three LED (light-emitting diode) headlamps respectively including (i) a first LED module which has a center of light distribution facing a direction of a vehicle's forward movement, (ii) a second LED module which has a center of light distribution on the right side of the direction of the vehicle's forward movement, and (iii) a third LED module which has a center of light distribution on the left side of the direction of the vehicle's forward movement. Brightness of each of these LED modules is controlled in accordance with a steering angle. In this technique, a light-projection range can be changed by a plurality of LED headlamps having respective different light-projection ranges.

### CITATION LIST

### Patent Literature

Patent Literature 1
Japanese Patent Application Publication, Tokukai, No. 2006-1393 A (Publication Date: Jan. 5, 2006)

### SUMMARY OF INVENTION

### Technical Problem

However, the technique disclosed in Patent Literature 1 requires a plurality of light-projection sections in principle. This causes problems such as high cost and an increase in size of the headlamp.

The present invention has been made in order to solve the above problems, and an object of the present invention is to provide an illumination device and a vehicle headlamp, each of which includes a single light-projection section and is thereby capable of changing a light-projection pattern without mechanically moving the light-projection section.

### Solution to Problem

An illumination device in accordance with one aspect of the present invention includes a light-projection section, a first light source provided substantially at a focal position of the light-projection section and a second light source provided in a position different from the focal position, lighting of the first light source and lighting of the second light source being controlled independently of each other, whereby a light-projection pattern of the illumination device can be changed.

### Advantageous Effects of Invention

According to one aspect of the present invention, it is possible to change the light-projection pattern with use of a single light-projection section, without mechanically moving the light-projection section.

### BRIEF DESCRIPTION OF DRAWINGS

FIG. 1 is a view schematically illustrating a configuration of a headlamp in accordance with an embodiment of the present invention.

FIG. 2(a) and FIG. 2(b) are cross-sectional views each schematically illustrating a configuration of the headlamp. FIG. 2(a) is a side view, and FIG. 2(b) is a top view.

FIG. 3 is a view illustrating directions in which light emitted from a light source 2A included in the headlamp is projected.

FIG. 4 is a view illustrating directions in which light emitted from a light source 2C included in the headlamp is projected.

FIG. 5 is a view illustrating another example of directions in which light emitted from the light source 2C included in the headlamp is projected.

FIG. 6 is a view illustrating a further example of directions in which light emitted from the light source 2C included in the headlamp is projected.

FIG. 7(a) and FIG. 7(b) are views each illustrating an example of a light-projection range observed when the headlamp is applied to an automobile. FIG. 7(a) is a view illustrating a light-projection range observed when only the light source 2A is turned on. FIG. 7(b) is a view illustrating a light-projection range observed when the light source 2A and the light source 2C are turned on.

FIG. 8(a) and FIG. 8(b) are views each illustrating another example of a light-projection range observed when the headlamp is applied to an automobile. FIG. 8(a) is a view illustrating a light-projection range observed when only the light source 2A is turned on. FIG. 8(b) is a view illustrating a light-projection range observed when the light source 2A and the light source 2B are turned on.

FIG. 9(a) and FIG. 9(b) are views each illustrating a further example of a light-projection range observed when the headlamp is applied to an automobile. FIG. 9(a) is a view illustrating a light-projection range observed when only the light source 2A is turned on. FIG. 9(b) is a view illustrating a light-projection range observed when the light source 2A and the light source 2C are turned on.

FIGS. 10(a), 10(b) and 10(c) are views each illustrating an example of a light-projection pattern on a screen provided in front of the headlamp.

FIG. 11(a) is a view illustrating an effect of light-distribution control on a curve, and FIG. 11(b) is a view illustrating an effect of light-distribution control at an intersection.

FIG. 12 is a view illustrating how lighting of the headlamp is controlled in accordance with the speed of an automobile.

FIG. 13 is a view illustrating an example using optical fibers for laser irradiation.

FIG. 14(a) and FIG. 14(b) are views schematically illustrating a configuration of a headlamp in accordance with another embodiment of the present invention. FIG. 14(a) is a perspective view illustrating an overall configuration of the headlamp, and FIG. 14(b) is a side view of a light source supporting section.

FIG. 15(a) and FIG. 15(b) are views schematically illustrating a configuration of a headlamp in accordance with a further embodiment of the present invention. FIG. 15(a) is a perspective view illustrating an overall configuration of the headlamp, and FIG. 15(b) is a side view of a light source supporting section.

FIG. 16 is a view schematically illustrating a configuration of a headlamp in accordance with still a further embodiment of the present invention.

FIG. 17 is a view illustrating directions in which light emitted from the light source 2C included in the headlamp is projected.

FIG. 18 is a view illustrating another example of directions in which light emitted from the light source 2C included in the headlamp is projected.

### DESCRIPTION OF EMBODIMENTS

### Embodiment 1

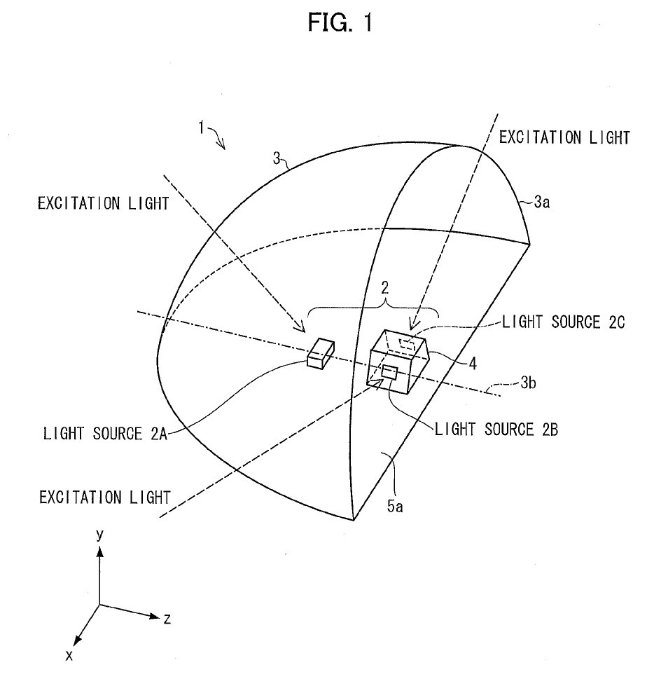

The following description discusses an embodiment of the present invention with reference to FIG. 1 to FIG. 13.

<Configuration of Headlamp 1>

The following describes a headlamp (a vehicle headlamp) 1 as an example of a vehicle headlamp of the present invention. The headlamp 1 meets the standards for light distribution characteristics of a driving headlamp (high beam) for automobiles. Note, however, that the vehicle headlamp of the present invention can be a headlamp for passing (low beam). Further, the vehicle headlamp can be realized as an illumination device for a vehicle or a moving object other than the automobile (for example, person, vessel, airplane, submarine, rocket, or the like), or can be realized as another illumination device for use in other applications. Examples of such an illumination device include a search light, a projector, a household illumination apparatus, a commercial illumination device, and an exterior illumination device.

FIG. 1 is a view schematically illustrating a configuration of the headlamp 1 in accordance with an embodiment of the present invention. As illustrated in FIG. 1, the headlamp 1 includes a light source 2A (first light source), a light source 2B (second light source), a light source 2C (second light source), a parabolic mirror (light-projection section, reflecting mirror) 3, and a light source holding section 4.

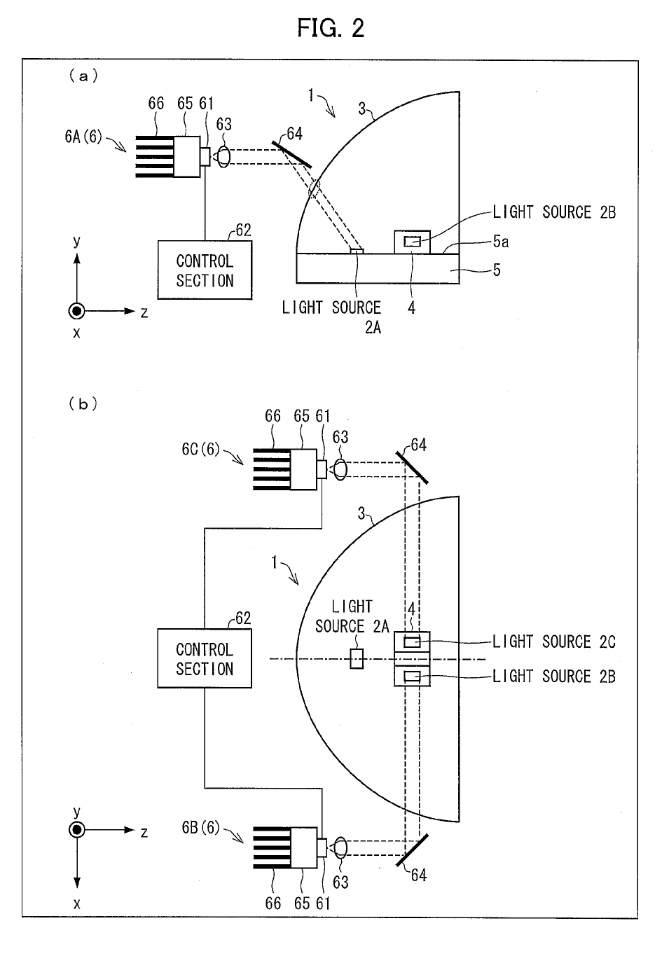

FIG. 2(a) and FIG. 2(b) are cross-sectional views each schematically illustrating a configuration of the headlamp 1. FIG. 2(a) is a side view, and FIG. 2(b) is a top view. As illustrated in FIG. 2(a) and FIG. 2(b), the headlamp 1 further includes a metal base 5, laser sources 6A to 6C, a control section 62, collimating lenses 63 and mirrors 64.

The headlamp 1 (i) controls, by the parabolic mirror 3, distribution of fluorescence that the light sources 2 emit upon receiving laser beams from their corresponding laser sources 6 and (ii) projects the fluorescence to the outside as illumination light. The light sources 2 include (i) the light source 2A which is provided substantially at a focal position of the parabolic mirror 3 and (ii) the light source 2B and the light source 2C each of which is provided in a position different from the substantially focal position.

The fluorescence emitted from the light sources 2A to 2C is reflected by the parabolic mirror 3, and projected to respective different ranges. By turning ON/OFF the laser sources 6A to 6C which emit laser beams to the light sources 2A to 2C respectively under control of the control section 62, a light-projection range of the headlamp 1 can be changed.

Next, details of each part of the headlamp 1 are described below.

(Parabolic Mirror 3)

The parabolic mirror 3 is a light-projection section for reflecting light emitted from a light source 2 and projecting the light in a predetermined direction. More specifically, the parabolic mirror 3 reflects the light emitted from the light source 2 so as to form a bundle of rays (illumination light) which travels within a predetermined solid angle. The parabolic mirror 5 can be for example a member that has a metal film on its surface or can be a member made of metal.

A reflecting surface of the parabolic mirror 3 includes at least a part of a partial curved surface, which is obtained by (i) rotating a parabola about its symmetric axis so as to form a curved surface (parabolic surface) and (ii) cutting the curved surface along a plane including the symmetric axis.

Note, however, that the reflecting mirror (reflector) serving as the light-projection section, which is applicable to the headlamp 1 of the present embodiment, is not limited to the parabolic mirror illustrated in FIG. 1 etc. For example, the reflecting mirror can be (i) a parabolic mirror having a closed circular opening or (ii) one that includes a part of the parabolic mirror. Further, the reflecting mirror is not limited to the parabolic mirror, and can be an ellipsoidal mirror, a free-form surface mirror or a multi-mirror (parabolic cylinder reflecting mirror).

As the light-projection section, (i) a light-projection lens or (ii) a combination of the reflecting mirror and the light-projection lens can be used. The light-projection lens is an optical system which transmits and refracts illumination light emitted from the light sources 2 to thereby project the illumination light in a predetermined direction.

The laser sources 6A to 6C are provided outside the parabolic mirror 3, and the parabolic mirror 3 has windows (not illustrated) each of which allows a laser beam to transmit or to pass therethrough. Each of the windows can be (i) an opening or (ii) a part that includes a transparent material capable of transmitting a laser beam.

In the following descriptions, an imaginary axis which passes through a focal point of the parabolic mirror 3 and extends in a main direction of light projection is referred to as a projection axis 3b. In the headlamp 1, the projection axis 3b is an axis which (i) passes through the focal point and a vertex (center of a base) of the parabolic mirror 3, (ii) is included in a symmetry plane of the parabolic mirror 3 and (iii) lies on a surface 5a of the metal base 5. The surface 5a of the metal base 5 is a surface on which the light source 2A is provided and which faces the reflecting surface of the parabolic mirror 3.

The symmetry plane of the parabolic mirror 3 is a plane with respect to which the parabolic mirror 3 is symmetric in a case where the parabolic mirror 3 has plane symmetry. In other words, the parabolic mirror 3 is symmetric with respect to the symmetry plane. The symmetry plane is an imaginary plane which includes the projection axis 3b and is perpendicular to the surface 5a of the metal base 5.

In an xyz coordinate space in FIG. 1, one of spaces separated by the symmetry plane, which one has x coordinates larger than that of the symmetry plane, is referred to as a right-side space, and the other of the spaces which has x coordinates smaller than that of the symmetry plane is referred to as a left-side space. Note, here, that an xz plane is parallel to the surface 5a of the metal base 5, and a z axis is parallel to the projection axis 3b.

The light source 2B emits light to the right-side space, and the light source 2C emits light to the left-side space (this is described later).

Note, however, that the term “symmetry plane” is for convenience of description, and therefore the parabolic mirror 3 does not necessarily have to have plane symmetry. It is only necessary that (i) an imaginary plane including the projection axis 3b of the parabolic mirror 3 be determined and (ii) a first space and a second space be defined by the imaginary plane.

Also note that a direction, in which light emitted from the light source 2A provided at the focal position of the parabolic mirror 3 is mainly projected, is referred to as a main projection direction.

(Light Sources 2)

Each of the light sources 2 is a light-emitting section which contains a phosphor (fluorescent material). The phosphor emits fluorescence upon receiving a laser beam (excitation light) emitted from its corresponding laser source 6. The headlamp 1 includes the light sources 2A to 2C serving as the light sources 2.

Each of the light sources 2A to 2C is (i) one that is obtained by dispersing phosphors in a sealing member or (ii) one that is obtained by solidifying a phosphor.

Examples of the phosphors contained in the light sources 2A to 2C include oxynitride phosphors (for example, sialon phosphor), nitride phosphors (for example, CASN (CaAlSiN₃) phosphor), and III-V group compound semiconductor nanoparticle phosphors (for example, indium phosphide: InP). Note, however, that the phosphors contained in the light sources 2A to 2C are not limited to those listed above, and can be other phosphors.

A type of phosphors to be used and wavelengths of laser beams can be selected so that illumination light of the headlamp 1 has a chromaticity falling within a desired range. For example, white light is generated when a mixture of blue, green and red phosphors is irradiated with a 405-nm laser beam.

Each of sealing members of the light sources 2A to 2C is, for example, a glass material (inorganic glass, organic-inorganic hybrid glass) or a resin material such as a silicone resin. The glass material can be low-melting glass. It is preferable that the sealing members are highly transparent. In a case where laser beams are high in power, it is preferable that the glass materials are highly resistant to heat.

(Light Source 2A)

The light source 2A is (i) provided substantially at the focal position of the parabolic mirror 3 and (ii) fixed on the surface 5a of the metal base 5. A distribution of light that the light source 2A emits upon receiving a laser beam is controlled by the parabolic mirror 3, and projected in front of the parabolic mirror 3.

For example, the light source 2A has a size of 0.5 mm×2.0 mm. Note, however, that the size is not limited to the above. It is preferable that a distribution of fluorescence emitted from the light source 2A is a Lambert distribution. The Lambert distribution is such that, assuming that an inclination angle between a normal to the top surface of the light source 2A and a beam of the fluorescence is θ, a radiation distribution of the fluorescence is approximated by cos(θ). Note here that light is most intense in a direction) (θ=0° of the normal to the light source. This direction (θ=0° is a direction in which the light is mainly emitted from the light source, and is referred to as an optical axis of the light source.

(Light Sources 2B and 2C)

Each of the light sources 2B and 2C is provided (i) substantially on the projection axis 3b and (ii) in a position different from the substantially focal position. Light emitted from each of the light sources 2B and 2C is projected at an angle to the projection axis 3b. The positions of the light sources 2B and 2C are described later in detail.

The light sources 2B and 2C are held, with the light source holding section 4, on the surface 5a of the metal base 5 at respective predetermined angles so that optical axes of the light sources 2B and 2C face respective different directions in the parabolic mirror 3.

Specifically, the direction and angle of the light source 2B are determined so that light emitted from the light source 2B strikes mainly a part, of the reflecting surface of the parabolic mirror 3, which is one of parts separated by the symmetry plane and lies in the right-side space. The part which lies in the right-side space is a part whose x coordinates are larger than the x coordinate of the symmetry plane in FIG. 1.

On the other hand, the direction and angle of the light source 2C are determined so that light emitted from the light source 2C strikes mainly a part, of the reflecting surface of the parabolic mirror 3, which is one of parts separated by the symmetry plane and lies in the left-side space. The part which lies in the left-side space is a part whose x coordinates are smaller than the x coordinate of the symmetry plane in FIG. 1.

In other words, a surface of the light source 2B, from which surface light is mainly emitted, faces the reflecting surface which lies in the right-side space of the parabolic mirror 3, whereas a surface of the light source 2C, from which surface light is mainly emitted, faces the reflecting surface which lies in the left-side space of the parabolic mirror 3.

For example, the optical axis (a direction in which light is mainly emitted, hereinafter referred to as a main direction of light emission) of the light source 2B is (i) included in the right-side space, (ii) inclined at approximately 45° with respect to the surface 5a of the metal base 5, and (iii) included in a plane substantially perpendicular to the symmetry plane.

Further, the optical axis of the light source 2C is (i) included in the left-side space, (ii) inclined at approximately 45° with respect to the surface 5a of the metal base 5, and (iii) included in a plane substantially perpendicular to the symmetry plane. Note, however, that inclinations and directions of the light sources 2B and 2C are not limited to those described above.

On the other hand, the light source 2A emits fluorescence to the almost entire reflecting surface of the parabolic mirror 3.

Therefore, a range of light emission from the light source 2B and the light source 2C in the parabolic mirror 3 is different from a range from light emission of the light source 2A in the parabolic mirror 3. Accordingly, light emitted from the light source 2B and the light source 2C has different intensity distributions on the reflecting surface of the parabolic mirror 3 from that of the light emitted from the light source 2A.

Furthermore, since one surface of each of the light sources 2B and 2C is in contact with the light source holding section 4, fluorescence is mainly emitted from another surface (light-emitting surface) which is not in contact with the light source holding section 4. That is, the fluorescence emitted from each of the light sources 2B and 2C travels within an angle of 180°. This means that the fluorescence has directivity. In other words, each of the light sources 2B and 2C is a light source that emits fluorescence (illumination light) within a predetermined angle range.

The above configuration makes it possible to project light from the light source 2B and light from the light source 2C in respective different directions. For example, the above configuration makes it possible to (i) project light from the light source 2B to the left relative to the front of the parabolic mirror 3 and (ii) project light emitted from the light source 2C to the right relative to the front of the parabolic mirror 3.

(Modified Example of Light Sources 2)

The light sources 2A to 2C can be light-emitting diodes (LED). In this case, since the LEDs themselves emit illumination light, an excitation light source for exciting a phosphor is not necessary.

(Light Source Holding Section 4)

As described earlier, the light source holding section 4 is a member which holds the light sources 2B and 2C so that the light sources 2B and 2C face toward desired directions. Note, here, that a member which holds the light source 2B and a member which holds the light source 2C can be provided separately.

The light sources 2B and 2C generate heat when irradiated with laser beams. Therefore, it is preferable that the light source holding section 4 is made of a material which has high thermal conductivity so that the heat generated from the light sources 2B and 2C can be dissipated.

(Metal Base 5)

The metal base 5 is a base which supports the parabolic mirror 3, the light source 2A and the light source holding section 4. The metal base 5 is made of metal such as aluminum. The material from which the metal base 5 is made is not limited to metal, and can be a material having high thermal conductivity other than metal. This configuration makes it possible to efficiently dissipate heat generated from the light source 2A (and the light sources 2B and 2C). If such an effect is not desired, the metal base 5 can be made of any material.

(Laser Sources 6)

The laser sources 6 are excitation light sources for exciting phosphors contained in the light sources 2A to 2C. The headlamp 1 includes three laser sources 6A to 6C serving as the laser sources 6. The laser source 6A irradiates the light source 2A with a laser beam, the laser source 6B irradiates the light source 2B with a laser beam, and the laser source 6C irradiates the light source 2C with a laser beam. The laser sources 6A to 6C have the same structures, but irradiate respective different light sources 2A to 2C with laser beams.

Each of the laser sources 6A to 6C is constituted by a semiconductor laser element 61, a heat sink 65 and a radiating fin 66.

(Semiconductor Laser Element 61)

The semiconductor laser element 61 is a light-emitting element which functions as an excitation light source that emits excitation light. The semiconductor laser element 61 can be one that has a light-emitting point in a single chip or one that has a plurality of light-emitting points in a single chip. The wavelength of a laser beam from the semiconductor laser element 61 is for example 405 nm (blue-violet) or 450 nm (blue). Note, however, that the wavelength is not limited to those.

The power of the semiconductor laser element 61 is not particularly limited. For example, the following configuration can be employed: (i) a laser beam of 3 W is emitted to the light source 2A so that light of 450 lumens is emitted from the light source 2A and (ii) a laser beam of 1.5 W is emitted to each of the light sources 2B and 2C so that light of 225 lumens is emitted from each of the light sources 2B and 2C.

Further, an optical axis of the laser beam emitted from the semiconductor laser element 61 of the laser source 6A is, for example, included in the symmetry plane and at an angle of 45° to the surface 5a of the metal base 5.

An optical axis of the laser beam emitted from the semiconductor laser element 61 of the laser source 6B is, for example, perpendicular to the symmetry plane (parallel to the surface 5a of the metal base 5) and included in the right-side space.

An optical axis of the laser beam emitted from the semiconductor laser element 61 of the laser source 6C is, for example, perpendicular to the symmetry plane (parallel to the surface 5a of the metal base 5) and included in the left-side space.

Note, however, that how to arrange the laser sources 6A to 6C and angles of laser irradiation are not limited to the above.

Furthermore, instead of such a semiconductor laser element, an LED can be used as an excitation light.

(Control Section 62)

The control section 62 controls output (ON/OFF) of at least one of the semiconductor laser elements 61 of the laser sources 6A to 6C, thereby controlling lighting of at least one of the light sources 2A to 2C in accordance with a signal from outside.

The control sections 62 is for example constituted by a driving circuit which drives the semiconductor laser elements 61 by supplying driving currents to the semiconductor laser elements 61. The control section 62 may include a CPU (central processing unit) which controls the driving circuit.

Note, here, that a single driving circuit can be provided for three semiconductor elements 61, or driving circuits can be provided for the respective three semiconductor elements 61. In the latter case, it is only necessary to provide a control section, which controls the three driving circuits in an integrated manner.

The control section 62 controls lighting of the laser sources 6A to 6C in accordance with the steering of or the speed of the automobile 7 which includes the headlamp 1. To this end, the control section 62 (i) receives a signal from a specific mechanism (external device) of the automobile 7 and (ii) controls lighting of at least one of the laser sources 6A to 6C in accordance with the signal thus received. The signal is, for example, a signal indicative of the speed or the steering direction of the automobile 7.

(Collimating Lens 63)

Each of the collimating lenses 63 transmits and refracts a laser beam emitted from its corresponding semiconductor laser element 61, thereby changing the laser beam to collimated light.

(Mirror 64)

Each of the mirrors 64 reflects a laser beam from its corresponding collimating lens 63 so as to guide the laser beam to its corresponding light source 2A, 2B or 2C which is to be irradiated with the laser beam.

(Heat Sink 65)

Each of the semiconductor laser elements 61 generates heat when it emits a laser beam by laser oscillation. Meanwhile, the semiconductor laser elements 61 cannot fully provide their performance at high temperatures. The heat sink accumulates heat generated by its corresponding semiconductor laser element 61, and transmits the heat so as to release the heat to its corresponding heat-radiating fin 66 etc. To this end, the heat sink 65 is preferably made of metal (such as aluminum) which has a high thermal conductivity, but may be made of any material provided that the material has a high thermal conductivity.

(Radiating Fin 66)

The radiating fin 66 serves as a radiating mechanism which radiates heat coming from its corresponding heat sink 65. The radiating fin 66 has a plurality of heat dissipating plates, whereby the area in contact with air is increased so that heat dissipation efficiency increases. Similarly to the heat sink 65, the radiating fin 66 is preferably made of a material which has a high thermal conductivity.

(Relationship Between Position of Light Source and Light-Projection Direction)

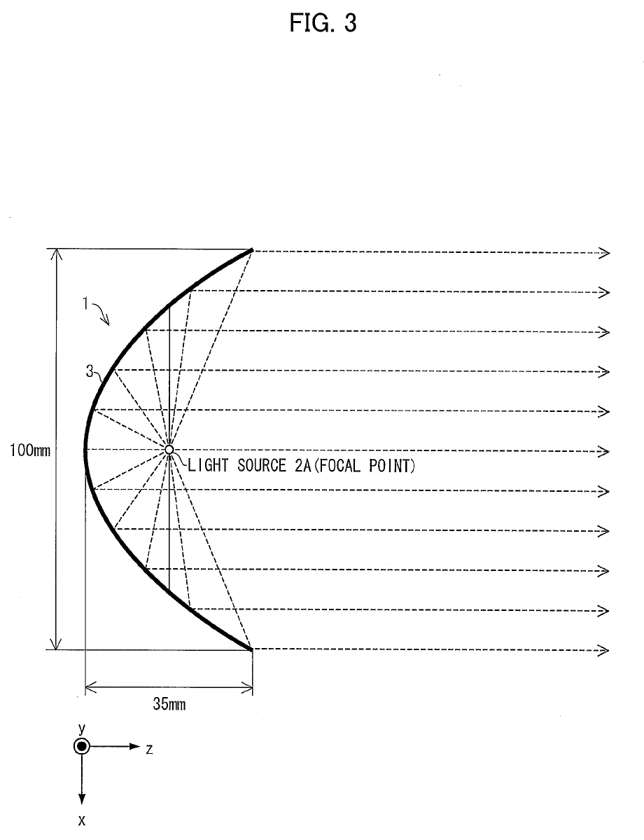

FIG. 3 is a view illustrating directions in which light emitted from the light source 2A is projected. FIG. 3 is a perspective view of the headlamp 1 as seen from a direction of a normal to the metal base 5 (i.e., as seen from a y axis direction). The parabolic mirror 3 used here is 35 mm in depth and has the opening 3a which is 100 mm in diameter.

As described earlier, the light source 2A is provided substantially at the focal position of the parabolic mirror 3, and the optical axis of the light source 2A extends in the y-axis direction. In this configuration, distribution of light emitted from the light source 2A is controlled by the parabolic mirror 3 so that the light is projected in a direction parallel to the projection axis 3b (i.e., in front of the parabolic mirror 3).

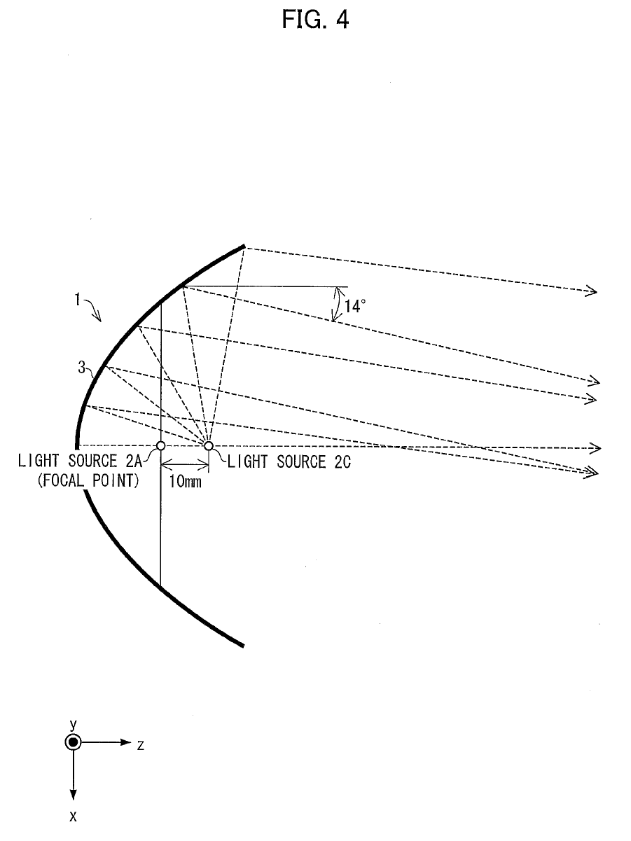

FIG. 4, which shows the same parabolic mirror 3 as is shown in FIG. 3, is a view illustrating directions in which light emitted from the light source 2C is projected. The light source 2C lies on the projection axis 3b, and is provided in a position shifted by 10 mm from the light source 2A toward the opening 3a.

Light emitted from the light source 2C is reflected by a part of the reflecting surface of the parabolic mirror 3, and projected in directions which are not parallel to the projection axis 3b. In other words, the light is projected in directions different from the directions in which light emitted from the light source 2A is projected. More specifically, in FIG. 4, the light emitted from the light source 2C is (i) mainly reflected at one, of halves of the reflecting surface of the parabolic mirror 3 separated by the symmetry plane, which is included in the left-side space and (ii) projected to the right relative to the front of the parabolic mirror 3 at an angle of approximately 14° to a plane parallel to the symmetry plane. Note, here, that an optical axis of the light source 2C extends in a direction of a negative x axis.

On the other hand, the light source 2B is provided substantially in the same position as the light source 2C, theoretically. Light emitted from the light source 2B in a direction of the x axis, which is the optical axis of the light source 2B, is projected so that the passes of the light are symmetrical to those of the light emitted from the light source 2C with respect to the symmetry plane. In other words, the light emitted from the light source 2B is (i) mainly reflected at one, of the halves of the reflecting surfaces of the parabolic mirror 3 separated by the symmetry plane, which is included in the right-side space and (ii) projected to the left relative to the front of the parabolic mirror 3.

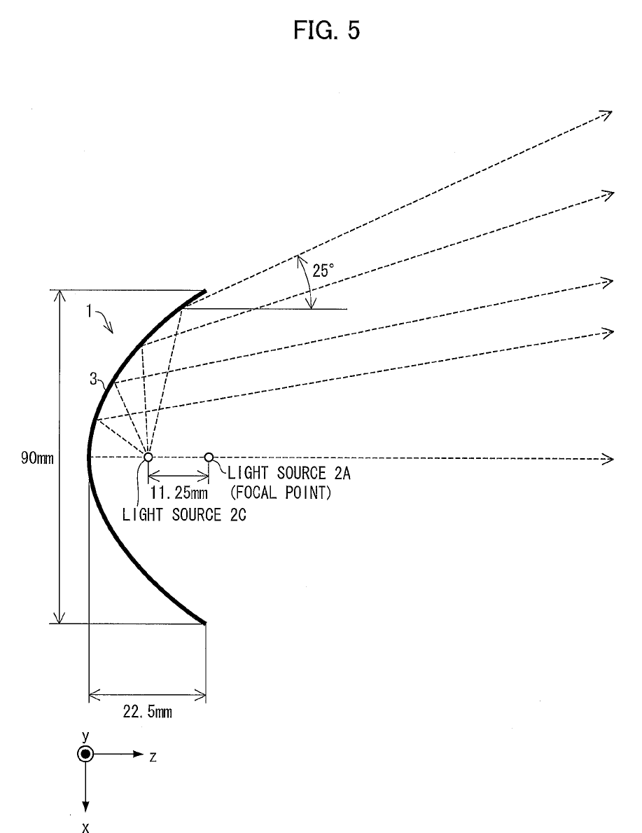

FIG. 5 is a view illustrating another example of directions in which light emitted from the light source 2C is projected. The parabolic mirror 3 used here has a diameter of 90 mm and a depth of 22.5 mm. In this example, the light source 2C lies on the projection axis 3b, and is provided in a position shifted by 11.25 mm from the light source 2A in a direction opposite to the opening 3a.

In this configuration, the light emitted from the light source 2C, whose optical axis extends in the direction of the negative x axis is reflected by a part of the reflecting surface of the parabolic mirror 3 and projected in directions not parallel to the projection axis 3b. Note here that the light emitted from the light source 2C is, unlike the light emitted from the light source 2C shown in FIG. 4, projected so as to gradually go away from the projection axis 3b. That is, the light emitted from the light source 2C shown in FIG. 5 is (i) mainly reflected at one, of the halves of the reflecting surface of the parabolic mirror 3 separated by the symmetry plane, which is included in the left-side space and (ii) projected to the left relative to the front of the parabolic mirror 3.

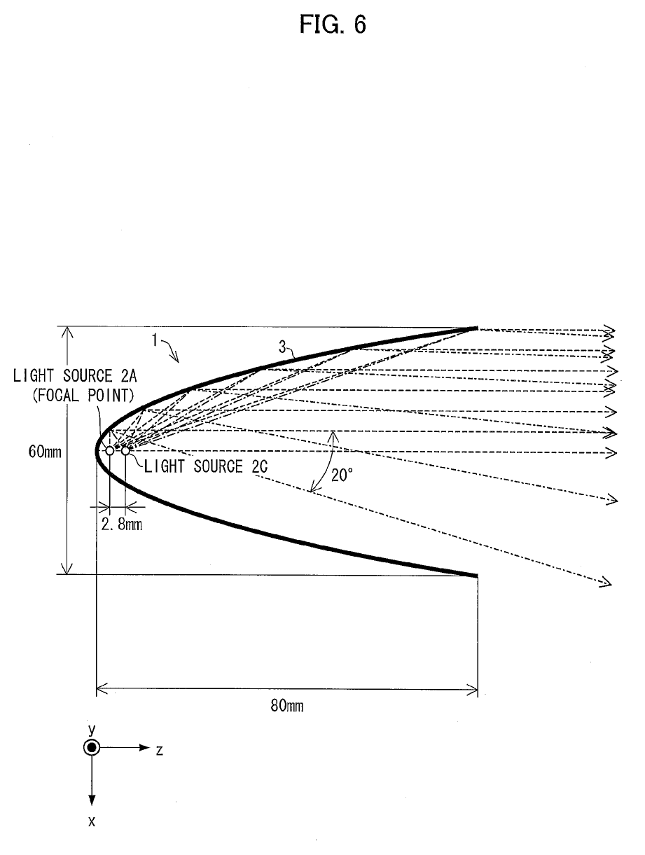

FIG. 6 is a view illustrating a further example of directions in which light emitted from the light source 2C is projected. The parabolic mirror 3 used here has a diameter of 60 mm and a depth of 80 mm. The light source 2C lies on the projection axis 3b, and is provided in a position shifted by 2.8 mm from the light source 2A toward the opening 3a. Note, here, that the optical axis of the light source 2C extends in the direction of the negative x axis.

In this configuration, the light emitted from the light source 2C is (i) mainly reflected at one, of the halves of the reflecting surface of the parabolic mirror 3 separated by the symmetry plane, which is included in the left-side space and (ii) projected to the right relative to the front of the parabolic mirror 3.

As has been described, directions in which light is projected vary depending on the positions of the light source 2B and the light source 2C relative to the focal position of the parabolic mirror 3. Therefore, by controlling the positions of the light sources 2B and 2C, it is possible to set desired directions in which light from these light sources is projected. Note that a mechanism capable of adjusting the positions of the light sources 2B and 2C may be provided.

(Light-Projection Range of Headlamp 1)

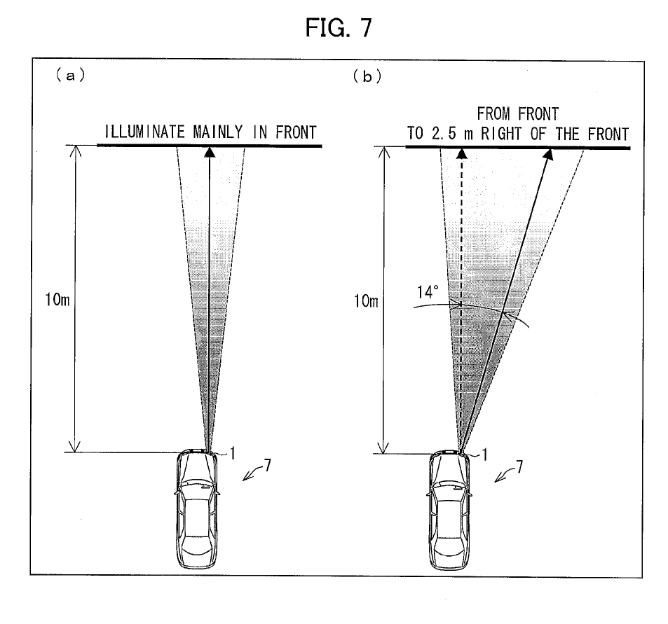

FIG. 7(a) and FIG. 7(b) are views each illustrating an example of a light-projection range observed when the headlamp 1, in which the light sources 2A to 2C are provided in positions described with reference to FIG. 4, is applied to an automobile 7. FIG. 7(a) is a view illustrating a light-projection range observed when only the light source 2A is turned on, and FIG. 7(b) is a view illustrating a light-projection range observed when the light source 2A and the light source 2C are turned on.

It is assumed that the headlamp 1 is provided to the automobile 7 such that the main projection direction of light emitted from the light source 2A is a direction of travel of the automobile 7. As illustrated in FIG. 7(a), when only the light source 2A is turned on, light emitted from the light source 2A is projected in front of the automobile 7.

On the other hand, as illustrated in FIG. 4, light emitted from the light source 2C is projected to the right relative to the front of the automobile 7 at an angle of approximately 14° to the projection axis 3b. Therefore, when the light source 2A and the light source 2C are turned on, the headlamp 1 can illuminate a region from the front to 2.5 m right of the front when measured in a position at a distance of 10 m from the automobile 7. That is, the light-projection range can be expanded to one direction. Note that, when the light source 2A and the light source 2B are turned on, the light-projection range can be expanded to the opposite direction.

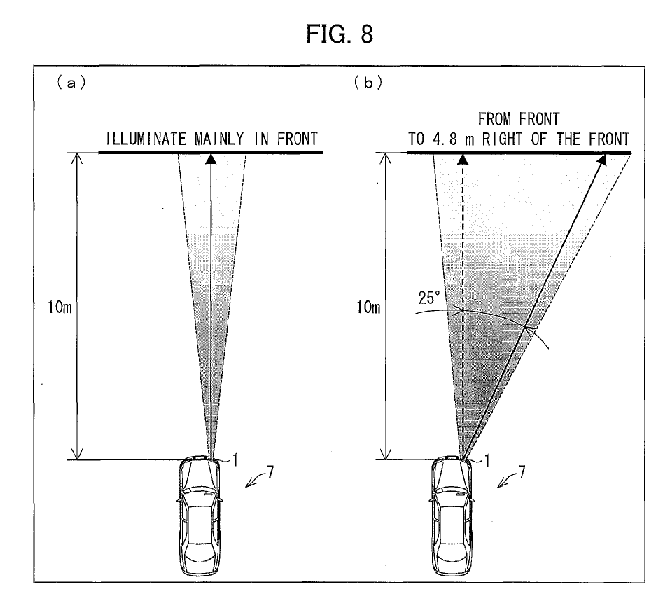

FIG. 8(a) and FIG. 8(b) are views each illustrating an example of a light-projection range observed when the headlamp 1, in which the light sources 2A to 2C are provided in the positions described with reference to FIG. 5, is applied to the automobile 7. FIG. 8(a) is a view illustrating a light-projection range observed when only the light source 2A is turned on, and FIG. 8(b) is a view illustrating a light-projection range observed when both the light source 2A and the light source 2B are turned on.

A light-projection range of light emitted from the light source 2A is the same as that illustrated in FIG. 7(a).

On the other hand, as illustrated in FIG. 5, light emitted from the light source 2C is projected to the left relative to the front of the automobile 7 at an angle of approximately 25° to the projection axis 3b. In contrast, light emitted from the light source 2B is projected to the right relative to the front of the automobile 7 at an angle of approximately 25° to the projection axis 3b.

Accordingly, by turning on the light source 2A and the light source 2B, the light-projection range of the headlamp 1 can be expanded to one direction so that the headlamp 1 illuminates a region from the front to 4.8 m right of the front when measured in a position at a distance of 10 m from the automobile 7. Note that, when the light source 2A and the light source 2C are turned on, the light-projection range can be expanded to the opposite direction.

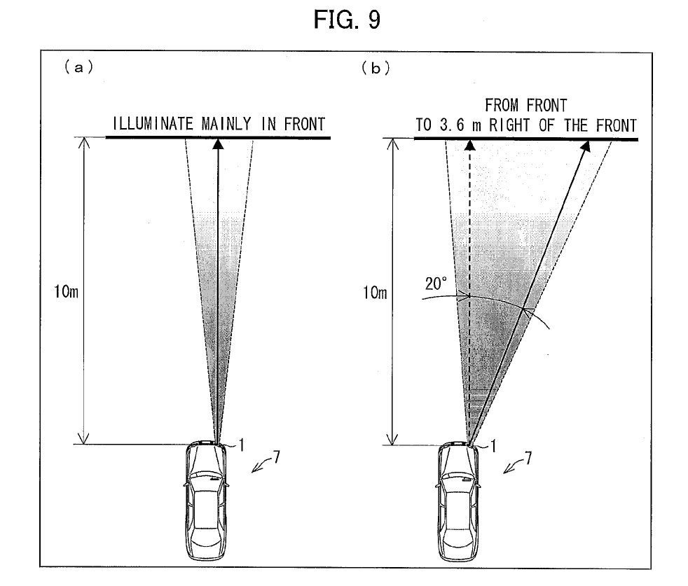

FIG. 9(a) and FIG. 9(b) are views each illustrating an example of a light-projection range observed when the headlamp 1, in which the light sources 2A to 2C are provided in the positions described with reference to FIG. 6, is applied to the automobile 7. FIG. 9(a) is a view illustrating a light-projection range observed when only the light source 2A is turned on, and FIG. 9(b) is a view illustrating a light-projection range observed when the light source 2A and the light source 2C are turned on.

The light-projection range of light emitted from the light source 2A is the same as that illustrated in FIG. 7(a).

On the other hand, as illustrated in FIG. 6, light emitted from the light source 2C is projected to the right-side space at an angle of approximately 20° to the projection axis 3b. Accordingly, by turning on the light source 2A and light source 2C, the light-projection range of the headlamp 1 can be expanded to one direction so that the headlamp 1 illuminates a region from the front to 3.6 m right of the front when measured in a position at a distance of 10 m from the automobile 7. Note here that, when the light source 2A and the light source 2B are turned on, the light-projection range can be expanded to the opposite direction.

(How to Control Lighting of Headlamp 1, and Light-Projection Pattern of Headlamp 1)

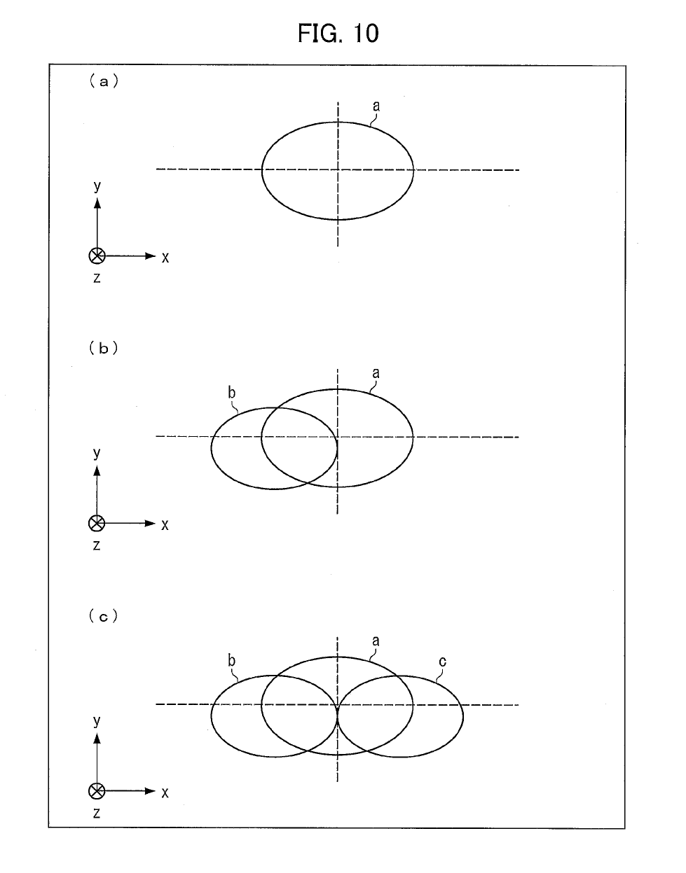

FIGS. 10(a), 10(b) and 10(c) are views each illustrating an example of a light-projection pattern on a screen provided in front of the headlamp 1 illustrated in FIG. 4. FIG. 10(a) is a view illustrating a light-projection pattern observed when only the light source 2A is turned on. FIG. 10(b) is a view illustrating a light-projection pattern observed when only the light sources 2A and 2B are turned on. FIG. 10(c) is a view illustrating a light-projection pattern observed when all the light sources 2A to 2C are turned on. Symbols “a” to “c” indicate spots formed by the light sources 2A to 2C, respectively.

As illustrated in FIG. 10(a), light emitted from the light source 2A is projected in front of the headlamp 1. As illustrated in FIG. 10(b) and FIG. 10(c), it is possible to gradually change the light-projection range by turning on the light source 2B and the light source 2C in addition to the light source 2A.

As described above, it is possible to change the light-projection pattern by independently controlling lighting of each of the light sources 2A to 2C. Accordingly, it is possible to change the light-projection pattern with use of a single parabolic mirror 3 without mechanically moving the parabolic mirror 3.

It should be noted that, since the examples illustrated in FIG. 10 are based on the assumption that the headlamp 1 is provided to the automobile 7, the light-projection range of the headlamp 1 is expanded to the right and left. However, in a case where an illumination device of the present invention is realized as an illumination device other than a vehicle headlamp, the light-projection range may be expanded vertically.

(How to Control Lighting of Headlamp 1 in Automobile 7)

[Control Lighting in Accordance with Steering]

Lighting of the light sources 2A to 2C can be controlled in accordance with the steering of the automobile 7. In the following example, a case in which the headlamp 1 described with reference to FIG. 4 is provided to the automobile 7 is taken as an example.

When a steering wheel of the automobile 7 is turned to the right, a signal indicating that the steering wheel is turned to the right is supplied to the control section 62. Upon receiving the signal, the control section 62 supplies a driving current to the semiconductor laser element 61 of the laser source 6C to cause the semiconductor laser element 61 to emit a laser beam by laser oscillation. As a result, the light source 2C emits fluorescence, and the fluorescence, which serves as illumination light, is projected to the right relative to the front of the automobile 7. On the other hand, when the steering wheel is turned to the left, the light source 2B emits fluorescence, which is projected to the left relative to the front of the automobile 7. This configuration makes it possible to automatically illuminate a direction of travel of the automobile 7.

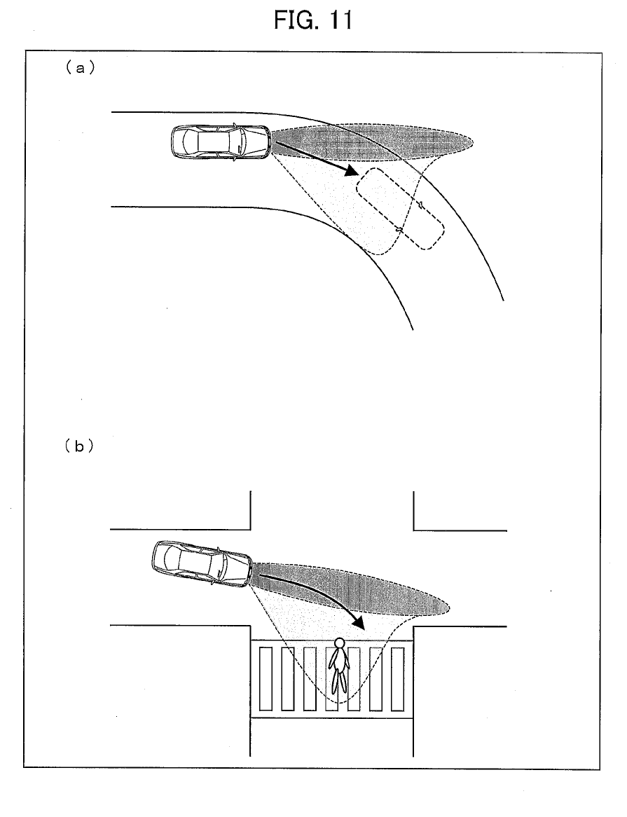

FIG. 11(a) and FIG. 11(b) are views illustrating effects of the headlamp 1. FIG. 11(a) is a view illustrating an effect of light-distribution control on a curve, and FIG. 11(b) is a view illustrating an effect of light-distribution control at an intersection.

By expanding a light-projection range to the right relative to the direction of travel of the automobile 7 when the automobile 7 is going around a right curve (see FIG. 11(a)), it becomes easy to check for safety in a direction in which the automobile 7 is about to travel. Furthermore, by expanding a light-projection range to the right relative to the direction of travel of the automobile 7 when the automobile 7 is turning to the right at an intersection (see FIG. 11(b)), it is possible to find a pedestrian in the intersection in an early stage.

[Control Lighting in Accordance with Speed of Automobile]

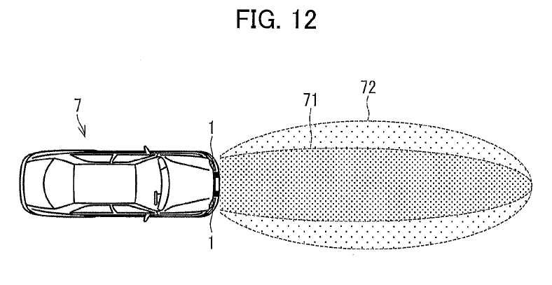

FIG. 12 is a view illustrating how lighting of the headlamp 1 is controlled in accordance with the speed of the automobile 7. Lighting of the light sources 2A to 2C may be controlled in accordance with the speed of the automobile 7.

For example, upon receiving from the automobile 7 a signal indicating a speed faster than a predetermined speed (i.e., in a case where the automobile 7 travels at a high speed), the control section 62 turns on only the light source 2A so as to project light having a light-projection pattern 71. On the other hand, upon receiving a signal indicating a speed slower than the predetermined speed (i.e., in a case where the automobile 7 travels at a low speed), the control section 62 turns on all the light sources 2A to 2C so as to project light having a light-projection pattern 72.

The automobile 7 travels at a low speed usually when traveling in a place where obstacles and pedestrians are likely to exist, such as urban areas. Therefore, it is preferable that the irradiation range of the headlamp 1 is expanded when the automobile 7 travels at a low speed.

With the above configuration, it is possible to illuminate a range that is suitable for the speed of the automobile 7.

(Modified Example of how to Emit Laser Beam)

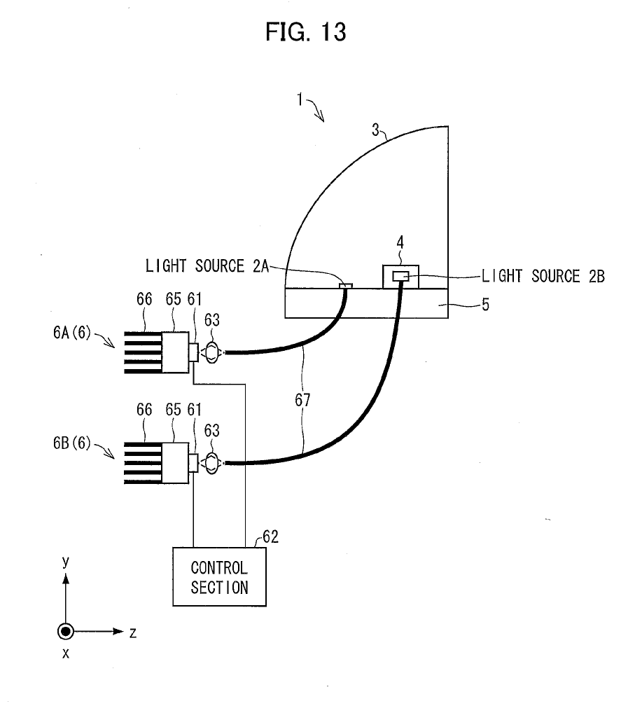

FIG. 13 is a view illustrating an example in which optical fibers 67 are used for emission of laser beams. In a case of FIG. 2, each of the light sources 2A to 2C receives, via a corresponding mirror 64, a laser beam emitted from a corresponding one of the laser sources 6A to 6C by laser oscillation. On the other hand, in a case of FIG. 13, each of the light sources 2A to 2C (the light source 2C is not illustrated) receives a laser beam via an optical fiber 67. The optical fiber 67 passes through the metal base 5, and the light source 2A receives the laser beam on its back.

Use of the optical fiber 67 makes it possible to more freely arrange the laser sources 6A to 6C, and thus possible to provide additional degrees of freedom in the design of the headlamp 1.

<Effect of Headlamp 1>

As has been described, according to the headlamp 1, it is possible to change a light-projection pattern with use of a single light-projection section without mechanically moving the light-projection section. Accordingly, the headlamp 1 brings about the following effects: it is possible to realize a smaller and lighter headlamp 1 which is less liable to troubles and is more responsive than a headlamp in which a light-projection section is mechanically moved.

### Embodiment 2

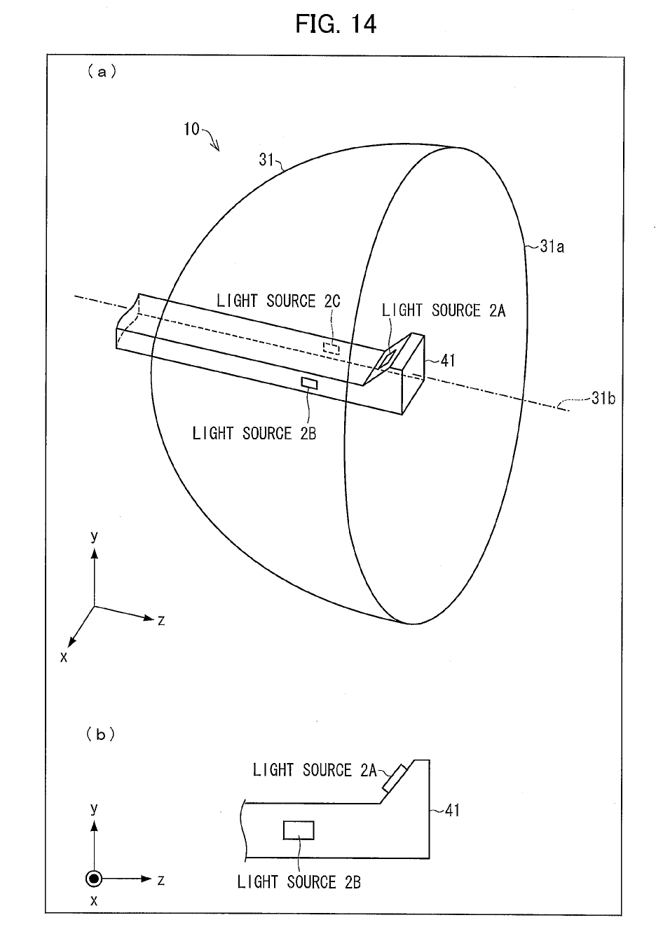

Another embodiment of the present invention is described below with reference to FIG. 14. Note that members which are the same as those in Embodiment 1 are assigned identical reference numerals, and their descriptions are omitted here.

<Configuration of Headlamp 10>

FIG. 14(a) and FIG. 14(b) are views schematically illustrating a configuration of a headlamp 10 in accordance with another embodiment of the present invention. FIG. 14(a) is a perspective view illustrating an overall configuration of the headlamp 10, and FIG. 14(b) is a side view of a light source holding section 41. The headlamp 10 of the present embodiment includes white LEDs which serve as light sources 2A to 2C. The headlamp 10 further includes (i) a parabolic mirror 31 serving as a light-projection section and (ii) the light source holding section 41 which holds the light sources 2A to 2C.

(Parabolic Mirror 31)

The parabolic mirror 31 is a reflector having a closed circular opening 31a, and is made of the same material as the parabolic mirror 3. Although the parabolic mirror 31 has substantially the same functions as the parabolic mirror 3, the area of a reflecting surface of the parabolic mirror 31 is approximately twice as large as that of the parabolic mirror 3.

Also in the parabolic mirror 31, an imaginary axis which passes through a focal point of the parabolic mirror 31 and the center of the opening 31a is referred to as a projection axis 31b.

Further, an imaginary plane including the projection axis 31b is referred to as a symmetry plane of the parabolic mirror 31. On the other hand, an imaginary plane which includes the projection axis 31b and is perpendicular to the symmetry plane is referred to as a horizontal plane.

A yz plane shown in FIG. 14(a) and FIG. 14(b) is parallel to the symmetry plane, and an xz plane shown in FIG. 14(a) and FIG. 14(b) is parallel to the horizontal plane.

(Light Source Holding Section 41)

The light source holding section 41 is a member which holds the light sources 2A to 2C in the parabolic mirror 31. The light source holding section 41 passes through a vertex of the parabolic mirror 31 and extends along the projection axis 31b.

In the example illustrated in FIG. 14(a), the light sources 2A to 2C are held with a single light source holding section 41. Note, however, that the number of light source holding sections 41 is not limited to one (1). For example, three members which hold the light sources 2A to 2C, respectively, may be provided.

A material from which the light source holding section 41 is made is not particularly limited. Note however that, in order to dissipate heat generated from the light sources 2A to 2C (LEDs), the light source holding section 41 is preferably made of a material having a high thermal conductivity.

As illustrated in FIG. 14(b), the light source holding section 41 has, at its end portion near the focal point of the parabolic mirror 31, an inclined surface where the light source 2A is provided.

The light source holding section 41 further has two side faces each of which is substantially parallel to the symmetry plane. The light sources 2B and 2C are provided on the respective side faces. A straight line which passes through a center of the light source 2B and a center of the light source 2C is substantially perpendicular to the symmetry plane.

(Light Source 2A)

The light source 2A is provided substantially at the focal position of the parabolic mirror 31 by being held by the light source holding section 41. As described earlier, the light source 2A is provided on the inclined surface of the light source holding section 41, and an optical axis (main direction of light emission) of the light source 2A (i) is included in the symmetry plane, (ii) is at an elevation angle of approximately 30° to the horizontal plane and (iii) is directed at the vertex of the parabolic mirror 31.

For example, the light source 2A has a size of 1 mm×4 mm and emits light of 500 lumens. Note, however, that this does not imply any limitation. A lighting distribution of fluorescence emitted from the light source 2A is preferably a Lambert distribution.

(Light Sources 2B and 2C)

The light sources 2B and 2C are provided in positions different from the focal position of the parabolic mirror 31 by being held with the light source holding section 41. More specifically, the light sources 2B and 2C are provided in positions shifted toward the vertex from the focal position, in substantially the same manner as in the example illustrated in FIG. 5.

Furthermore, the light source 2B emits light to a space (referred to as a right-side space) which (i) is one of spaces separated by the symmetry plane and (ii) has x coordinates larger than that of the symmetry plane. On the other hand, the light source 2C emits light in a direction (to a left-side space) opposite to the direction in which the light source 2B emits the light.

As described above, the light source 2B emits light to a first space, which is one of a plurality of internal spaces of the parabolic mirror 31 defined by any plane(s). The light source 2C emits light to a second space, which is one of the plurality of internal spaces but is different from the first space.

Each of the light sources 2B and 2C, for example, has a size of 2 mm×2 mm and emits light of 300 lumens. Note, however, that this does not imply any limitation. The distribution of fluorescence emitted from each of the light sources 2B and 2C is preferably a Lambert distribution.

(White LED)

Each of the white LEDs used as the light sources 2A to 2C emits white light having a color temperature of 5000 K. Note, however, that this does not imply any limitation. Each of the white LEDs used as the light sources 2A to 2C can be one that emits white light having other color temperature or light of a color other than white.

Note that, depending on countries or regions, there may be a law which demands that illumination light of a vehicle must be white that has a chromaticity falling within a specific range. In such a case, the white LEDs of the present embodiment are suitable.

<Effect of Headlamp 10>

As described above, the headlamp 10 has white LEDs serving as the light sources 2A to 2C. Such a headlamp 10 brings about the following effect: the structure of the headlamp 10 becomes more simple than a configuration in which a phosphor is excited by a laser beam.

### Embodiment 3

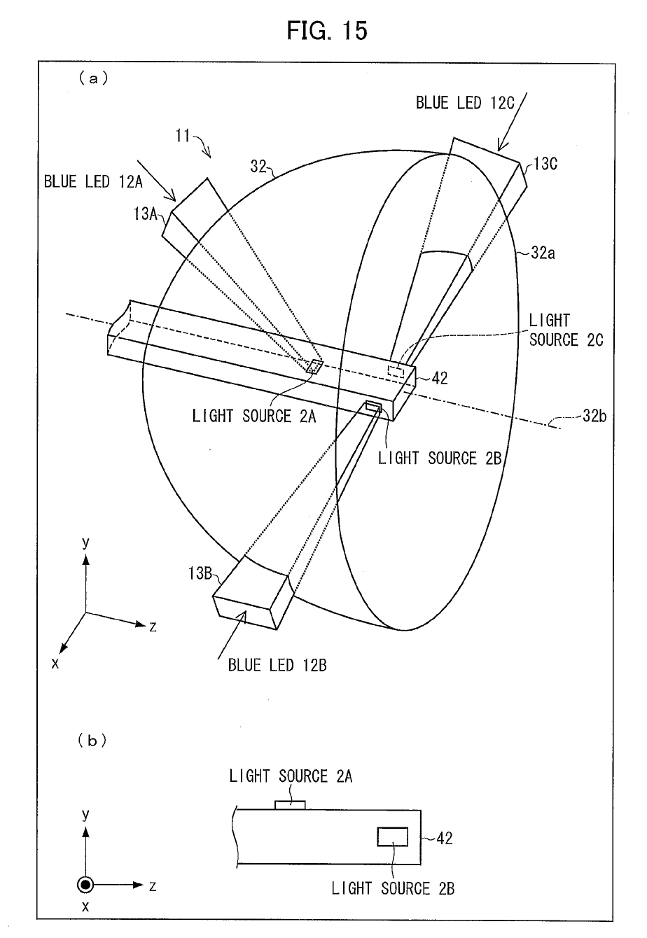

A further embodiment of the present invention is described below with reference to FIG. 15. Note that members which are the same as those in Embodiments 1 and 2 are assigned identical reference numerals, and their descriptions are omitted here.

[Configuration of Headlamp 11]

FIG. 15(a) and FIG. 15(b) are views schematically illustrating a configuration of a headlamp 11 in accordance with a further embodiment of the present invention. FIG. 15(a) is a perspective view illustrating an overall configuration of the headlamp 11, and FIG. 15(b) is a side view of a light source holding section 42. The headlamp 11 of the present embodiment includes, as the light sources 2A to 2C, phosphor layers each of which emits yellow light (hereinafter referred to as yellow-emitting phosphor layers). The light sources 2A to 2C are excited by blue LEDs 12A to 12C. Light beams emitted from the blue LEDs 12A to 12C are concentrated on the light sources 2A to 2C by rod lenses 13A to 13C, respectively. Furthermore, the headlamp 11 includes (i) a parabolic mirror 32 serving as a light-projection section and (ii) a light source holding section 42 which holds the light sources 2A to 2C.

(Parabolic Mirror 32)

The parabolic mirror 32 is substantially the same as the parabolic mirror 31, except that the parabolic mirror 32 has holes (not illustrated) through which the rod lenses 13A to 13C are inserted.

Also in the parabolic mirror 32, an imaginary axis which passes through a focal point of the parabolic mirror 32 and a center of the opening 32a is referred to as a projection axis 32b.

Furthermore, an imaginary plane including the projection axis 32b is referred to as a symmetry plane of the parabolic mirror 32. Moreover, an imaginary plane which includes (i) the projection axis 32b and (ii) is perpendicular to the symmetry plane is referred to as a horizontal plane. A yz plane shown in FIG. 15(a) and FIG. 15(b) is parallel to the symmetry plane, and an xz plane shown in FIG. 15(a) and FIG. 15(b) is parallel to the horizontal plane.

(Light Source Holding Section 42)

The light source holding section 42 is a member which holds the light sources 2A to 2C in the parabolic mirror 32. The light source holding section 42 passes through a vertex of the parabolic mirror 32 and extends along the projection axis 32b.

A material from which the light holding section 42 is made is not particularly limited. Note however that, in order to dissipate heat generated from the light sources 2A to 2C (phosphors), the light source holding section 42 is preferably made of a material having a high thermal conductivity.

As illustrated in FIG. 15(b), the light source holding section 42 has two side faces each of which is substantially parallel to the horizontal plane. One of the side faces of the light source holding section 42, which one faces in a y-axis direction, has the light source 2A thereon in a position near a focal point of the parabolic mirror 32.

Furthermore, the light source holding section 42 has two side faces each of which is substantially parallel to the symmetry plane. On the side faces, the light sources 2B and 2C are provided, respectively. A straight line which passes through a center of the light source 2B and a center of the light source 2C is substantially perpendicular to the symmetry plane.

(Light Source 2A)

The light source 2A is provided substantially at a focal position of the parabolic mirror 32 by being held by the light source holding section 42. As described above, the light source 2A is provided on the side face, of the light source holding section 42, which faces in the y axis direction. An optical axis (main direction of light emission) of the light source 2A is included in the symmetry plane and substantially perpendicular to the horizontal plane.

For example, the light source 2A has a size of 0.5 mm×2 mm and emits light of 450 lumens. Note, however, that this does not imply any limitation. A distribution of fluorescence emitted from the light source 2A is preferably a Lambert distribution.

(Light Sources 2B and 2C)

The light sources 2B and 2C are provided in positions different from the focal position of the parabolic mirror 32 by being held by the light source holding section 42. More specifically, the light sources 2B and 2C are provided in positions shifted from the focal position toward the opening 32a, in substantially the same manner as in the example illustrated in FIG. 4.

Furthermore, the light source 2B emits light to a space (referred to as a right-side space) which (i) is one of spaces separated by the symmetry plane and (ii) has x coordinates larger than that of the symmetry plane. On the other hand, the light source 2C emits light in a direction (to a left-side space) opposite to the direction in which the light source 2B emits the light.

As described above, the light source 2B emits light to a first space, which is one of a plurality of internal spaces of the parabolic mirror 32 defined by any plane(s). The light source 2C emits light to a second space, which is one of the plurality of internal spaces but is different from the first space.

For example, each of the light sources 2B and 2C has a size of 1 mm×1 mm and emits light of 250 lumens. Note, however, that this does not imply any limitation. A distribution of fluorescence emitted from each of the light sources 2B and 2C is preferably Lambert distribution.

(Yellow-Emitting Phosphor Layer)

The yellow-emitting phosphor layers emit yellow fluorescence by being excited by excitation light from the blue LEDs 12A to 12C, respectively. The yellow fluorescence is mixed with the excitation light, whereby white light is emitted. Note that YAG phosphors can be used as the yellow-emitting phosphor layers.

(Blue LEDs 12A to 12C)

Each of the blue LEDs 12A to 12C is an LED which (i) is made of mainly gallium nitride (GaN), (ii) emits blue light and (iii) serves as an excitation light source. Each of the blue LEDs 12A to 12C used here emits light having a wavelength of, for example, 450 nm. Furthermore, a blue laser can be used as the excitation light source instead of the blue LED.

(Rod Lenses 13A to 13C)

The rod lenses 13A to 13C concentrate the excitation light emitted from the blue LEDs 12A to 12C on the light sources 2A to 2C, respectively. Each of the rod lenses 13A to 13C used here is tapered. The rod lenses 13A to 13C are arranged such that excitation light beams are incident on the light sources 2A to 2C, respectively, at an angle of 45°. There is a gap of 1 mm between an exit end of each of the rod lenses 13A to 13C and a corresponding one of the light sources 2A to 2C.

<Effect of Headlamp 11>

Since the headlamp 11 includes the rod lenses 13A to 13C as described above, the headlamp 11 makes it possible to concentrate excitation light from the excitation light sources and irradiate the light sources 2A to 2C with the excitation light thus concentrated. This is advantageous especially in a case where excitation light beams from a plurality of excitation light sources are to be concentrated on the light sources 2A to 2C.

### Embodiment 4

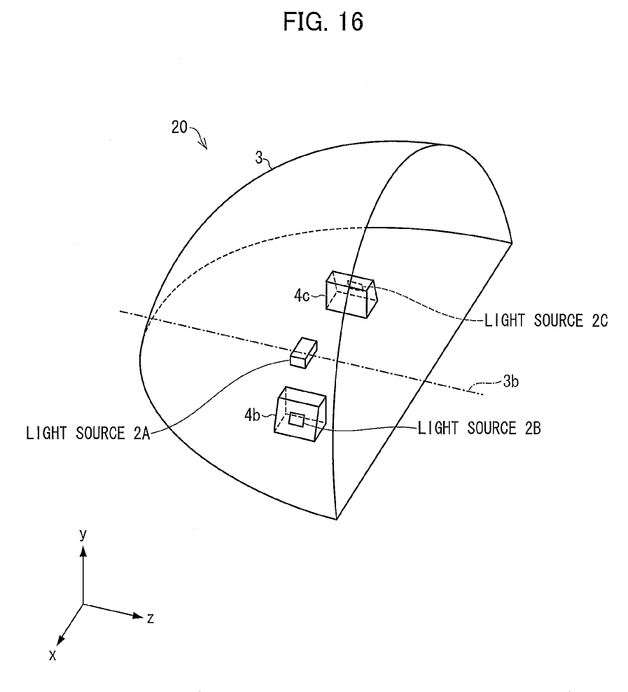

Still a further embodiment of the present invention is described below with reference to FIG. 16. Note that members which are the same as those in Embodiments 1 to 3 are assigned identical reference numerals, and their descriptions are omitted here.

FIG. 16 is a view schematically illustrating a configuration of a headlamp 20 in accordance with the present embodiment. As illustrated in FIG. 16, the headlamp 20 is the same as the headlamp 1, except that the light sources 2B and 2C are provided in positions different from those in the headlamp 1.

According to the headlamp 20, the light sources 2B and 2C are held with their corresponding light source holding sections 4b and 4c in respective different positions at a distance from the projection axis 3b. The light source holding sections 4b and 4c are made of the same material as the light source holding section 4, and an angle at which each of the light sources 2B and 2C is held is also the same as that of the light source holding section 4.

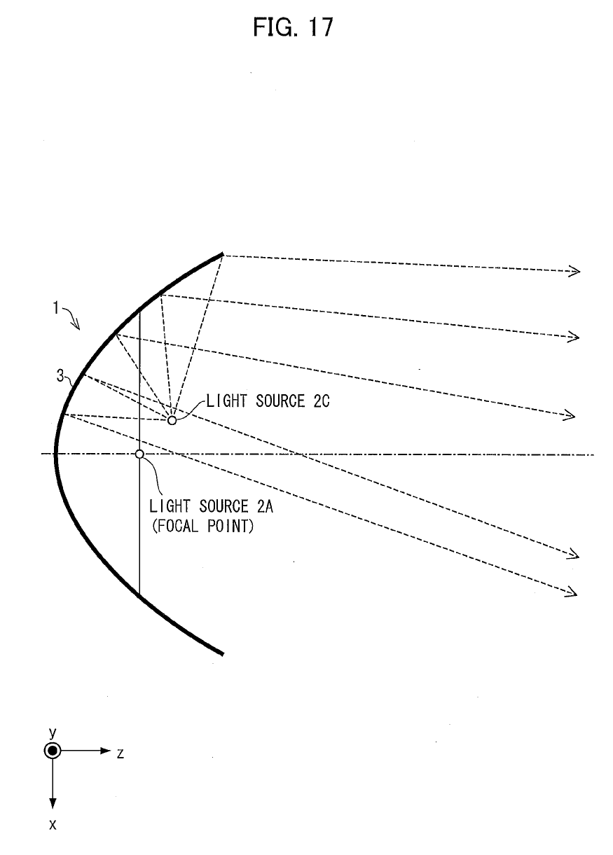

FIG. 17 is a view illustrating directions in which light emitted from the light source 2C of the headlamp 20 is projected. The light emitted from the light source 2C is reflected at a part of a reflecting surface of the parabolic mirror 3. Specifically, the light is mainly reflected at part, of the reflecting surface of the parabolic mirror 3, which is included in a left-side space, and the light is projected to the right relative to the front of the parabolic mirror 3.

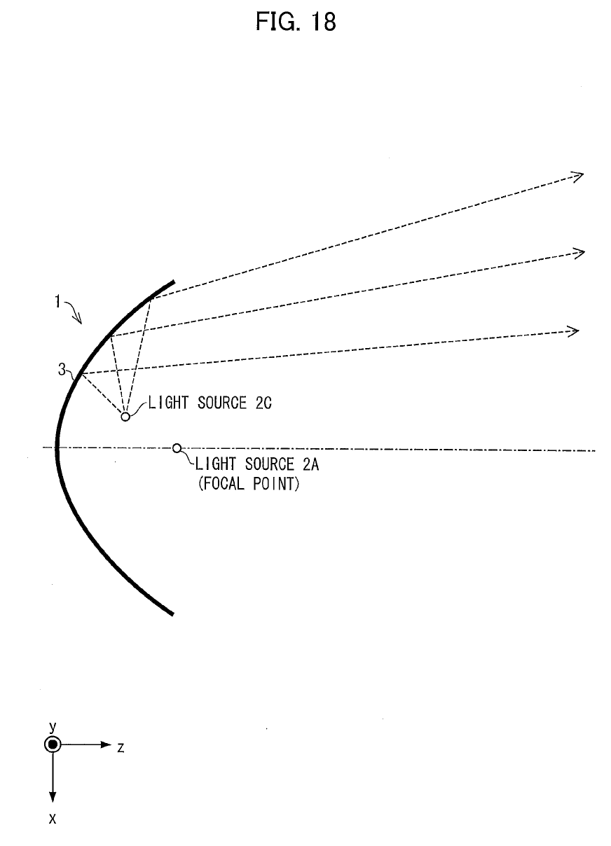

As described above, the light sources 2B and 2C do not necessarily have to be provided on the projection axis 3b. Similarly, as illustrated in FIG. 18, the light source 2C can be provided so as to be closer to a vertex of the parabolic mirror 3 than the light source 2A is. FIG. 18 is a view illustrating another example of directions in which light emitted from the light source 2C of the headlamp 20 is projected. The parabolic mirror 3 shown in FIG. 18 corresponds to the parabolic mirror 3 shown in FIG. 5. In the example illustrated in FIG. 18, the light source 2C is provided in a position shifted from the focal position of the parabolic mirror 3 by 13.6 mm in a direction of a negative z axis and 8.3 mm in a direction of a negative x axis.

Depending on the position of the light source 2C, light may be projected not only to the left relative to the front of the parabolic mirror 3 but also to the right relative to the front of the parabolic mirror 3. Therefore, it is preferable to control the position of the light source 2C so that the light is projected in a desired range. The same is true with the position of the light source 2B.

(Additional Remarks)

An illumination device in accordance with one aspect of the present invention includes a light-projection section, a first light source provided substantially at a focal position of the light-projection section and a second light source provided in a position different from the focal position, lighting of the first light source and lighting of the second light source being controlled independently of each other, whereby a light-projection pattern of the illumination device can be changed.

According to the above configuration, the first light source is provided substantially at the focal position of the light-projection section. Light emitted from the first light source provided substantially at the focal position is projected to a first light-projection range by the light-projection section. In general, light emitted from a light source provided at a focal position is projected in front of the light-projection section.

On the other hand, the second light source is provided at a position different from the focal position. Therefore, a distribution of light emitted from the second light source is controlled by the light-projection section in a manner different from that for the distribution of the light emitted from the first light source. As a result, the light emitted from the second light source is projected to a range (a second light-projection range) different from the first light-projection range.

Furthermore, lighting of each of the first and second light sources is controlled independently. This makes it possible to emit (i) only first illumination light derived from the first light source, (ii) only second illumination light derived from the second light source or (iii) both the first illumination light and the second illumination simultaneously. This makes it possible to change the light-projection pattern.

This makes it possible to change the light-projection pattern with use of a single light-projection section, without mechanically moving the light-projection section.

Note that (i) the first light-projection range and the second light-projection range can partly overlap each other and (ii) the first light-projection range can be included in the second light-projection range.

The illumination device in accordance with one aspect of the present invention is preferably configured such that light emitted from the second light source is projected by the light-projection section in a direction different from a direction in which light emitted from the first light source is projected by the light-projection section.

According to the above configuration, the light emitted from the second light source is projected in a direction different from a direction in which the light emitted from the first light source is projected. For example, the light emitted from the first light source is projected in front of the light-projection section, and the light emitted from the second light source is projected to the right or left relative to the front of the light-projection section.

Therefore, when the illumination device is provided to a vehicle, it is possible to project the light, which is emitted from the second light source in a direction corresponding to a direction in which the vehicle travels.

Note that “the light emitted from the second light source is projected in a direction different from a direction in which the light emitted from the first light source is projected” means that a maximum illuminance point of a light-projection spot derived from the light emitted from the second light source is different in position from a maximum illuminance point of a light-projection spot derived from the light emitted from the first light source. The maximum illuminance point of the light-projection spot is a position where the illuminance is the highest in the light-projection spot.

The illumination device in accordance with one aspect of the present invention is preferably configured such that the second light source emits light so that the light travels at an angle to an imaginary axis which (i) passes through a focal point of the light-projection section and (ii) extends in a main direction of light projection.

According to the above configuration, the light emitted from the second light source travels in a direction different from a direction in which the imaginary axis extends. Therefore, regardless of whether the second light source lies on the imaginary axis or not, the light emitted from the second light source is unevenly distributed inside the light-projection section. For example, in a case where the light-projection section has a reflecting surface, the reflecting surface is not evenly irradiated with the light emitted from the second light source, but a part of the reflecting surface is intensively irradiated with the light emitted from the second light source.

As a result, it is possible to cause the direction in which the light emitted from the second light source is projected to be different from the direction in which the light emitted from the first light source is projected.

The illumination device in accordance with one aspect of the present invention is preferably configured such that the second light source includes a plurality of light sources which emit light in respective different directions in the light-projection section.

According to the above configuration, light beams emitted from the respective plurality of light sources serving as the second light source travel in respective different directions in the light-projection section, and are subjected to respective different light distribution controls. As a result, the light beams are projected outward in respective different directions.

Therefore, the configuration makes it possible to realize not only the light-projection spot derived from the light emitted from the first light source but also a plurality of light-projection spots formed in respective different directions.

The illumination device in accordance with one aspect of the present invention can be configured such that the second light source is provided in a position at a distance from the imaginary axis which (i) passes through a focal point of the light-projection section and (ii) extends in a main direction of light projection.

According to the above configuration, the second light source is provided not on the imaginary axis. Therefore, light from the second light source is emitted to the light-projection section unevenly. For example, in a case where the light-projection section has a reflecting surface, the reflecting surface is not evenly irradiated with the light emitted from the second light source. Therefore, a light intensity distribution on the reflecting surface is not uniform.

Therefore, the configuration makes it possible to cause a direction in which the light emitted from the second light source is projected outward to be different from a direction in which the light emitted form the first light source is projected outward.

The illumination device in accordance with one aspect of the present invention is preferably configured such that the light-projection section is a reflecting mirror having a reflecting surface and an intensity distribution, on the reflecting surface, of light emitted from the second light source is different from an intensity distribution, on the reflecting surface, of light emitted from the first light source.

According to the above configuration, the intensity distribution, on the reflecting surface of the light-projection section, of the light emitted from the first light source is different from the intensity distribution, on the reflecting surface of the light-projection section, of the light emitted from the second light source.

Therefore, the configuration makes it possible to cause a direction in which the light emitted from the first light source is projected outward to be different from a direction in which the light emitted form the second light source is projected outward.

It is preferable that the illumination device in accordance with one aspect of the present invention further includes a control section for controlling lighting of at least one of the first and second light sources in accordance with a signal from outside.

According to the above configuration, it is possible to change a light-projection pattern in accordance with the signal from outside. The signal from outside is, for example, a signal indicative of a direction in which a vehicle including the illumination device is traveling.

The illumination device in accordance with tone aspect of the present invention can be configured such that the first light source or the second light source includes (i) a light-emitting diode or (ii) a phosphor which emits fluorescence upon receiving excitation light.

The illumination device in accordance with one aspect of the present invention can be configured such that the first light source or the second light source includes a phosphor which emits fluorescence upon receiving a laser beam.

According to the above configuration, as the first light source or the second light source, the light-emitting diode or the phosphor (fluorescent material) which emits fluorescence upon receiving excitation light can be used. In particular, an illumination device having high brightness can be realized by using the phosphor which emits fluorescence upon receiving a laser beam.

Furthermore, a vehicle headlamp in accordance with one aspect of the present invention can include an illumination device, the illumination device including a light-projection section, a first light source provided substantially at a focal position of the light-projection section, and a second light source provided in a position different from the focal position, lighting of the first light source and lighting of the second light source being controlled independently of each other, whereby a light-projection pattern of the illumination device can be changed.

The vehicle headlamp in accordance with one aspect of the present invention is preferably configured such that light emitted from the second light source is projected, by the light-projection section, to the right or left relative to a direction of travel of a vehicle.

The illumination device is suitably applicable to a vehicle headlamp. In a case where the illumination device is applied to a vehicle headlamp, when the vehicle turns right or left, it is possible to illuminate a direction in which the vehicle is about to travel, by projecting the light emitted from the second light source to the right or left relative to a direction of travel of the vehicle.

It is preferable that the vehicle headlamp in accordance with one aspect of the present invention further includes a control section for controlling lighting of the first light source and the second light source in accordance with steering of the vehicle.

According to the above configuration, since lighting of the first light source and the second light source is controlled in accordance with the steering of the vehicle, it is possible to automatically illuminate a direction in which the vehicle travels.

It is preferable that the vehicle headlamp in accordance with one aspect of the present invention further includes a control section for controlling lighting of the first light source and the second light source in accordance with a speed of the vehicle.

According to the above configuration, since lighting of the first light source and the second light source is controlled in accordance with the speed of the vehicle, it is possible to illuminate a range suitable for the vehicle's speed. For example, (i) the first light source is turned on when the vehicle is moving at a high speed and (ii) the first light source and the second light source are turned on when the vehicle is moving at a low speed.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention can be used in various illumination devices such as a vehicle headlamp, an illumination device for a moving object other than vehicles, a search light, and a projector.

### REFERENCE SIGNS LIST

1, 10, 11, 20 Headlamp (vehicle headlamp)
2 Light source
2A Light source (first light source)
2B, 2C Light source (second light source)
3, 31, 32 Parabolic mirror (light-projection section, reflecting mirror)
3a, 31a, 32a Opening
3b, 31b, 32b Light-projection axis
4, 4b, 4c, 41, 42 Light source holding section
5 Metal base
6, 6A to 6C Laser source
7 Automobile
12A to C Blue LED
13A to C Rod lens
61 Semiconductor laser element
62 Control section
63 Collimating lens
64 Mirror
65 Heat sink
66 Radiating fin
67 Optical fiber

1. An illumination device comprising:
a light-projection section;
a first light source provided substantially at a focal position of the light-projection section; and
a second light source provided in a position different from the focal position,
lighting of the first light source and lighting of the second light source being controlled independently of each other, whereby a light-projection pattern of the illumination device can be changed.

2. The illumination device as set forth in claim 1, wherein light emitted from the second light source is projected by the light-projection section in a direction different from a direction in which light emitted from the first light source is projected by the light-projection section.

3. The illumination device as set forth in claim 1, wherein the second light source emits light so that the light travels at an angle to an imaginary axis which (i) passes through a focal point of the light-projection section and (ii) extends in a main direction of light projection.

4. The illumination device as set forth in claim 3, wherein the second light source includes a plurality of light sources which emit light in respective different directions in the light-projection section.

5. The illumination device as set forth in claim 1, wherein the second light source is provided in a position at a distance from an imaginary axis which (i) passes through a focal point of the light-projection section and (ii) extends in a main direction of light projection.

6. The illumination device as set forth in claim 1, wherein:
the light-projection section is a reflecting mirror having a reflecting surface; and
an intensity distribution, on the reflecting surface, of light emitted from the second light source is different from an intensity distribution, on the reflecting surface, of light emitted from the first light source.

7. An illumination device as set forth in claim 1, further comprising a control section for controlling lighting of at least one of the first and second light sources in accordance with a signal from outside.

8. The illumination device as set forth in claim 1, wherein the first light source or the second light source includes (i) a light-emitting diode or (ii) a phosphor which emits fluorescence upon receiving excitation light.

9. The illumination device as set forth in claim 1, wherein the first light source or the second light source includes a phosphor which emits fluorescence upon receiving a laser beam.

10. A vehicle headlamp comprising an illumination device,
the illumination device including
a light-projection section,
a first light source provided substantially at a focal position of the light-projection section, and
a second light source provided in a position different from the focal position,
lighting of the first light source and lighting of the second light source being controlled independently of each other, whereby a light-projection pattern of the illumination device can be changed.

11. The vehicle headlamp as set forth in claim 10, wherein light emitted from the second light source is projected, by the light-projection section, to the right or left relative to a direction of travel of a vehicle.

12. A vehicle headlamp as set forth in claim 11, further comprising a control section for controlling lighting of the first light source and the second light source in accordance with steering of the vehicle.

13. A vehicle headlamp as set forth in claim 11, further comprising a control section for controlling lighting of the first light source and the second light source in accordance with a speed of the vehicle.
